(19) United States
(12) Patent Application Publication
(10) Pub. No.: US 2012/0300176 A1
(43) Pub. Date: Nov. 29, 2012

(54) Dual projection screen system

(76) Inventors: Mark Charles Roberts, Rancho Palos Verdes, CA (US); Alexander Morrison Rosson, Santa Monica, CA (US)

(21) Appl. No.: 13/134,058

(22) Filed: May 27, 2011

(51) Int. Cl. G03B 21/56; G03B 21/14

(52) U.S. Cl. 353/10; 359/449; 353/94; 353/121

(57) ABSTRACT

A dual-screen system and method for projecting contents of different formats are disclosed. The system includes a first screen for viewing content of a first format and a second screen for viewing content of a different format. Both screens are independently movable along a rail between respective viewing and stowed positions, with the respective viewing positions for the screens each being set at a given distance from a projector and having a fixed spatial relation to an audience area. Such a system facilitates the projection and viewing of content having different formats by allowing each screen to be accurately positioned in a repeatable manner, thus reducing the need for equipment re-adjustments when changing from one screen to another.

### FIELD OF THE INVENTION

This invention relates to a dual projection screen system for projecting content having different formats.

### BACKGROUND

Screening rooms are used to project movies during the production process for review, assessment or adjustment in a way that closely resembles the environment in which they will be exhibited. Thus, the screening room environment should exceed in most, if not all, pertinent qualities, compared to the environment in which the movie will be exhibited. This ensures that during a critical viewing, any flaw or mismatch present in the movie will be clearly visible to the production team, even though it may be less apparent in an exhibition theatre. This allows the production crew to ensure that the movie contains no unexpected quality issues.

In the case of a screening room suitable for use with 3-dimensional (3D) presentations, a high-gain screen is used to overcome the light-loss inherent in 3D projection systems. However, the high-gain screen is not well suited for review of, or adjustments to, non-3D presentations, which typically are not presented on a high-gain screen. Thus, viewing a 2-dimensional (2D) presentation on a high-gain screen produces non-optimal conditions for critical viewing and interferes with the production process.

In some cases, separate screening rooms are configured for 2D and 3D presentations. However, this wastes resources when one or the other format is not currently called for and a screening room lies dormant. In other cases, a 3D-ready screening room is used for a 2D presentation, though the presentation suffers in that situation.

In still other cases, a 2D screen is permanently located on the front wall of the screening room with a separate 3D screen being wheeled in on a frame for 3D presentations, and pushed to the side of the room at other times. However, the presence of the 3D screen, even off to the side, can be a sufficient distraction that may substantially degrade the usability of the review room for critical viewing. In addition, such a system presents potential safety concerns, e.g., a large frame (for providing stable support for the 3D screen) is difficult and hazardous for one person to manage, and a wheeled frame also poses a trip hazard. Furthermore, since the two screens are at distinct locations in their respective viewing positions, i.e., one ahead or in front of the other, it is necessary to re-adjust the projector, e.g., re-focus and re-convergence, when changing from one screen to the other, to account for the different throw (distance) between the projector and the screen in use. Additionally, it is also difficult to return a mobile frame accurately to the same position after each change between 2D and 3D screens.

In other cases such as retractable screens that are mechanically rolled up, the surface of high-quality projection screens, especially 3D screens, is easily damaged by repeated rolling and unrolling, or mere flexure. A screen used for critical viewing, once damaged, must be replaced because it cannot be repaired. Additionally, one screen rolling down in front of a fixed screen will still result in the two screens having distinct throws as discussed above.

Thus, there is a need for improved projection screen systems for projecting content having different formats.

### SUMMARY OF THE INVENTION

Embodiments of the present invention provide improvements over conventional systems by allowing either one of two screens to be moved into viewing positions such that each screen can be placed at respective fixed distances from one or more projectors in a repeatable manner, such that equipment re-adjustments can be avoided when exchanging the screens for viewing content of different formats. A system of the present invention is particularly useful for use in a screening room that does not have adequate ceiling height to allow the unused screen to be moved vertically out of the way, nor wings (an offstage area) to allow the unused screen to be moved laterally off stage. It also allows the use of projection screen materials not durable enough for repeated flexing, such as rolling and unrolling, as may occur by having two screens on a continuous belt or in a roll-up configuration.

One embodiment provides a system, which includes a first screen movable on a rail between a first viewing position and a first stowed position, and a second screen movable on the rail between a second viewing position and a second stowed position. The system is configured such that when the first screen is in the first viewing position for receiving projected content of a first format, the second screen is in the second stowed position; and when the second screen is in the second viewing position for receiving projected content of a second format different from the first format, the first screen is in the first stowed position.

Another embodiment provides a method of projecting content with different formats, which includes: providing a first screen movable on a rail between a first viewing position and a first stowed position, the first screen being compatible with viewing content of a first format; and providing a second screen movable on the rail between a second viewing position and a second stowed position, the second screen being compatible with viewing content of a second format different from the first format. The method further includes performing at least one of: (a) projecting content of the first format onto the first screen at the first viewing position while keeping the second screen in the second stowed position; and (b) projecting content of the second format onto the second screen at the second viewing position while keeping the first screen in the first stowed position.

### BRIEF DESCRIPTION OF THE DRAWINGS

The teachings of the present invention can be readily understood by considering the following detailed description in conjunction with the accompanying drawings, in which:

FIG. 1 shows one configuration of a screening room with a first screen in a viewing position and a second screen in a stowed position;

FIG. 2 shows the screening room of FIG. 1 with the first screen in an intermediate position between a viewing and stowed position, and the second screen in its stowed position;

FIG. 3 shows the screening room of FIG. 1 with the first screen in a stowed position and the second screen in an intermediate position between its stowed and viewing position;

FIG. 4 shows the screening room of FIG. 1 with the second screen in viewing position, and the first screen in a stowed position; and

FIGS. 5A-B show two top views of another embodiment with a curved screen and a flat screen in respective viewing and stowed positions.

To facilitate understanding, identical reference numerals have been used, where possible, to designate identical elements that are common to the figures. The drawings are not to scale, and one or more features may be expanded or reduced for clarity.

### DETAILED DESCRIPTION

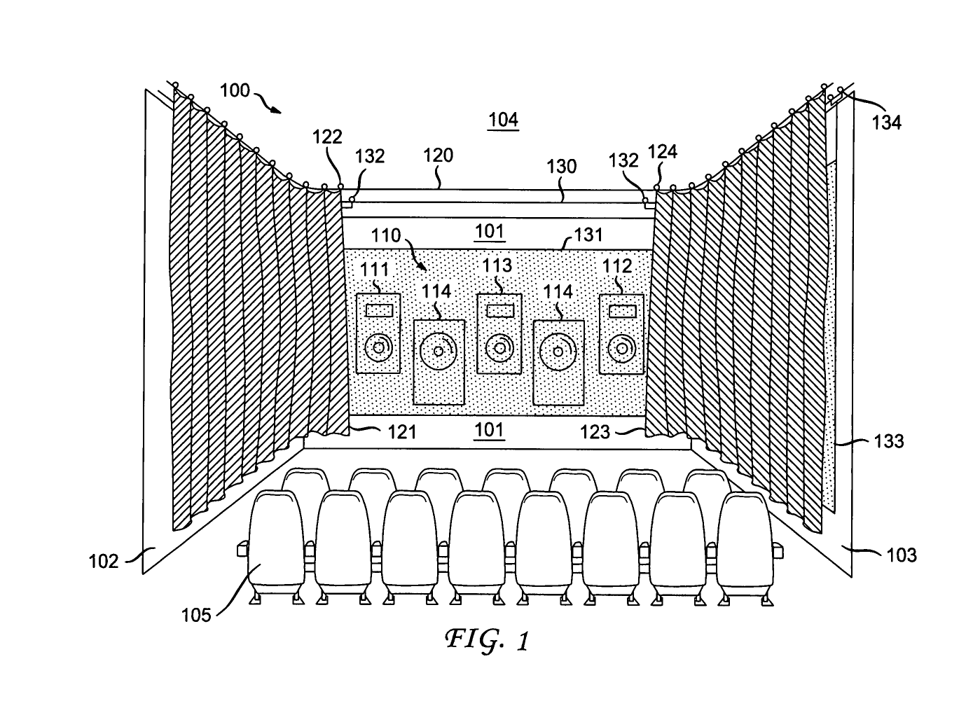

FIG. 1 shows a generally rectangular or quadrilateral screening or review room 100 having a front wall 101, left side wall 102, right side wall 103, ceiling 104, and a projection booth (not shown) opposite front wall 101 for accommodating or mounting one or more projectors and other film, digital cinema, or video equipment. In general, the review room 100 can be any arbitrary shape, as long as it has sufficient space along its front wall to accommodate a screen during viewing of a show, and sufficient space near or adjacent to the front wall (e.g., along side walls) for stowing a screen when it is not being used. Seats 105, and in some cases, workstations (not shown), allow small parties to sit facing the front wall 101. In this example, the screening room 100 is configured to be relatively compact, e.g., having a width substantially the same as the width of the audience area. Mounted in or on the front wall 101 are main speakers 110, which include left speaker 111, right speaker 112, center speaker 113, and subwoofers 114. Other speakers (not shown), including surround speakers, may be present elsewhere in the review room 100.

FIG. 1 shows two projection screens 131 and 133 compatible with viewing content of two different formats. A first screen 133 is in its stowed position along the right side wall 103, and hidden behind or protected by a right curtain 123. A second screen 131 is in a viewing position along the front wall 101, i.e., in front of speakers 110, opposite the projection booth and usable for projection and viewing of content. The top edge may optionally be covered by a valence (not shown). While in use in its viewing position, the left and right edges of left screen 131 may also be covered slightly by right and left curtains 121 and 123, which may serve as masking.

Each of left and right screens 131 and 133 is a single integral unit that may be constructed as a solid structure, or may be formed of a flexible fabric stretched over a rigid frame. Suitable screens of the latter implementation are manufactured by Stewart Filmscreen Corporation, e.g., Luxus Deluxe Screenwall.

Left and right screens 131 and 133 hang from or are attached to respective left screen rollers 132 and right screen rollers 134 (only one shown in FIG. 1), which are supported by a screen rail 130 that goes around the front wall 101 and at least portions of the left and right walls 102, 103 of the review room 100. Screen rail 130 can be attached to either the ceiling or the front and side walls using a variety of components such as bolts or other suitable fasteners. Screen rollers 132, 134 can travel along screen rail 130, carrying or transporting left and right screens 131, 133 to and from their respective stowed positions along side walls 102, 103, to their respective viewing positions along the front wall 101.

Screens 131 and 133 are different types of projection screen used for viewing content of different formats. In particular, one screen is suitable for 3D projection, e.g., a silver screen such as that made from the Silver 3D™ specialty fabric available from Stewart Filmscreen) and the other suitable for traditional 2D projection, e.g., a matt screen made from UltraMatte 150 flexible front projection screen material, also available from Stewart Filmscreen.

The 2D and 3D screens may be similarly perforated (including unperforated), and be of similar thickness and weight so as to offer similar acoustic transmission properties relative to the speakers 110 on wall 101. Otherwise, the sound system (not shown) for driving speakers 110 should use a distinct equalization for each screen in viewing position.

A curtain rail 120 is attached to ceiling 104 and runs from the left side of room 100, across the front, to the right side of the room. The curtain rail 120 is positioned farther from the walls than the screen rail 130. Rollers 122 and 124 are provided on curtain rail 120 for attaching or coupling to a left-side curtain 121 and right-side curtain 123, respectively. As shown in FIG. 1, left-side curtain 121 and right-side curtain 123 are in their respective extended positions used during viewing of content projected on screen 131, with one of the curtains (curtain 123 in this case) hiding at least most of the stowed-away screen 133 from the audience's view. If desired, the side curtains or another curtain may also be used to cover some or part of the screen along the front wall.

In some embodiments, two separate curtain rails can be used, i.e., one on the left and one on the right side of the room, with no curtain rail near the center of the front wall 101. However, a continuous curtain rail may provide better strength, alignment, and less of a propensity to glint (e.g., from edges) when a show is being projected.

Examples of rails and rollers suitable for use with the screens and curtains described above are available from Automatic Devices Company (ADC), of Allentown, Pa. In particular, the RIG-I-FLEX Model 140 Series Curtain Tracks is a line of products that includes aluminum No. 1400-BL Channel, which can be used for screen rail 130 or curtain rail 120. The ADC's No. 4251 Scenery Carrier can serve as screen rollers, and No. 4201-BL Single Carrier is suitable for use as curtain rollers. ADC's end stop No. 1409 (not shown in the figures) may be used to prevent the curtain rollers from leaving or traveling off the ends of curtain rail 120. In some embodiments, a valence (not shown) may be included to hide rails 120, 130, and the corresponding rollers 122, 124, 132, 134 from the view of the audience.

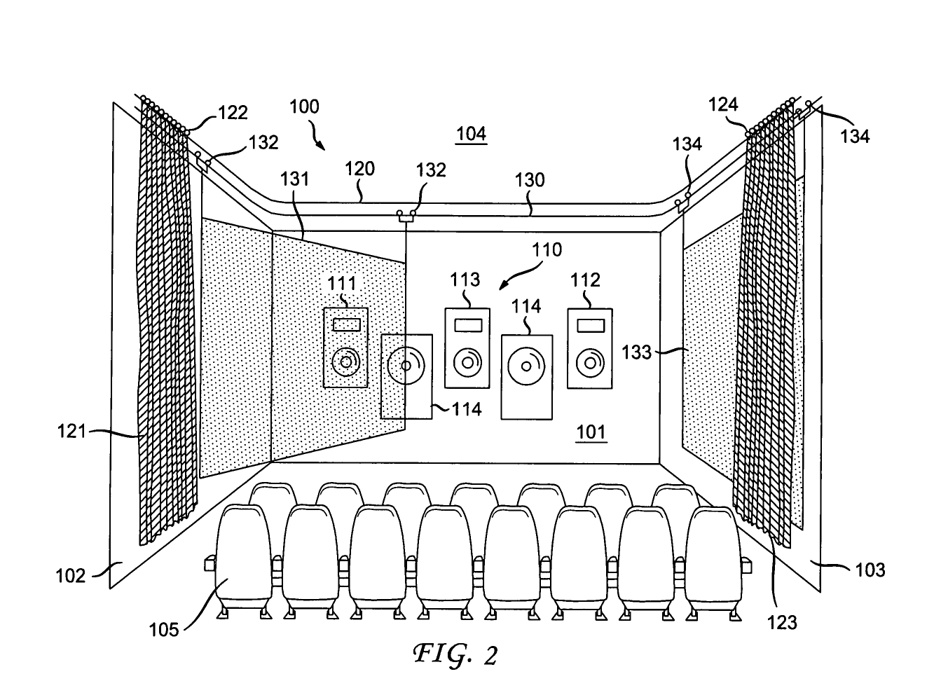

FIGS. 1-4 illustrate a sequence of steps in which the left screen 131 is replaced by the right screen 133 for projection or viewing purpose. The sequence starts by first moving both left and right curtains 121 and 123 from their extended positions in FIG. 1 to their fully open positions in FIG. 2, with left curtain rollers 122 and right curtain rollers 124 in their respective rearmost positions along curtain rail 120. Subsequent movement of the screens is facilitated by having both left curtain 121 and right curtain 123 fully retracted or pulled away from the front wall 101.

As shown in FIG. 2, rollers 132 are provided near the two upper corners of screen 131 for coupling to the rail 130 for support and transport of the screen. As left screen 131 is moved from its viewing position through its intermediate or transitional position in FIG. 2, right screen 133 is still in its stowed position along right wall 103.

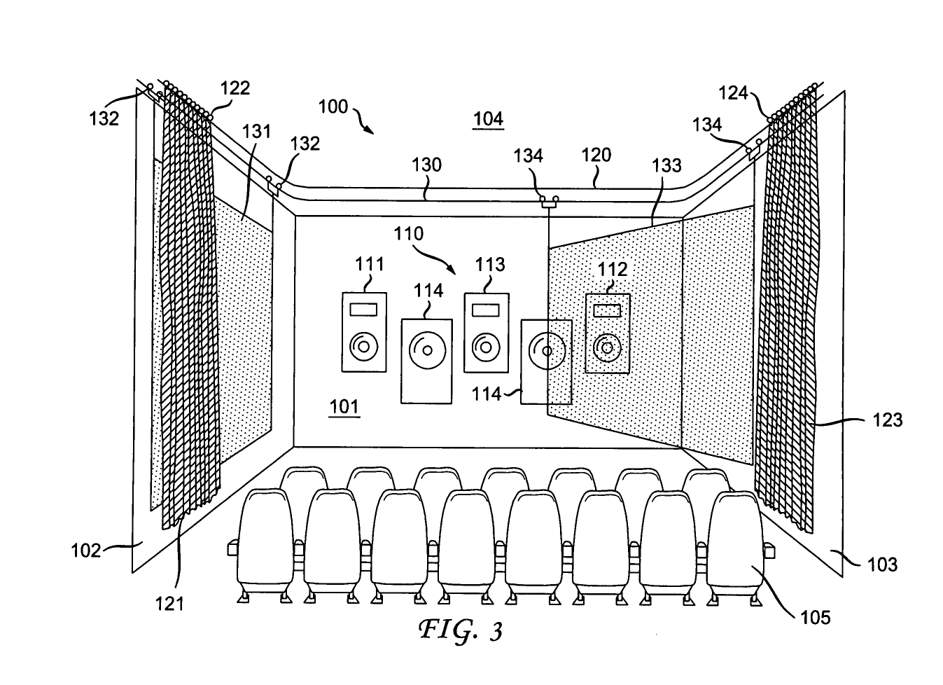

FIG. 3 shows screen 133 being moved through its intermediate position as it transitions to the viewing position, with screen 131 hanging from rail 130 in its stowed position along left wall 102. Rollers 134 are provided near the two upper corners of screen 133 for coupling to the rail 130 for support and transport of the screen.

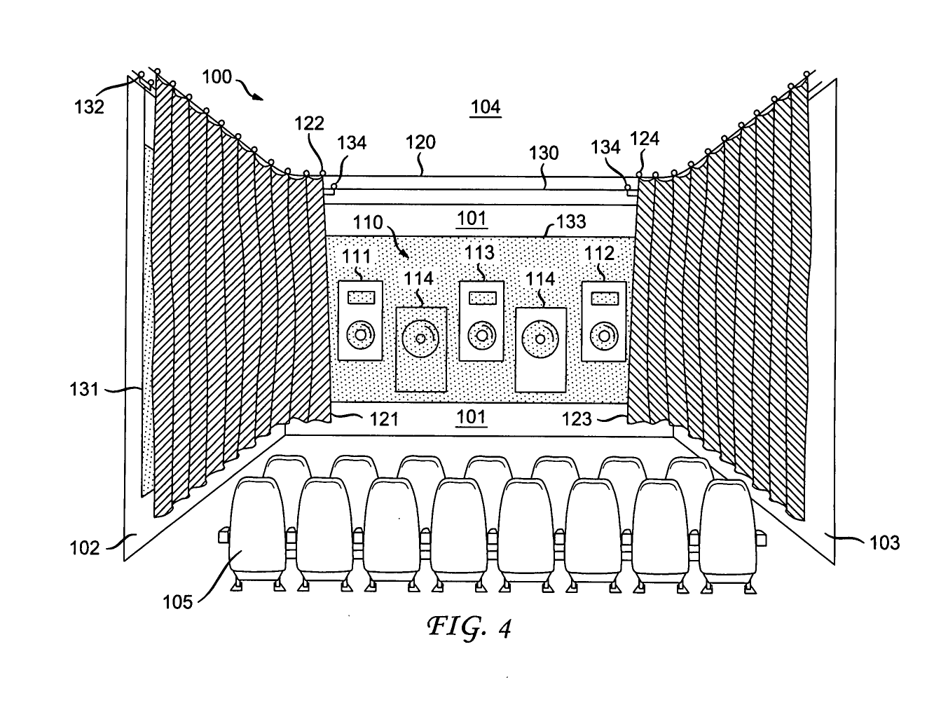

FIG. 4 shows the right screen 133 in its viewing position along front wall 101 and supported by rollers 134 on the rail 130, with left and right curtains 121 and 123 being extended to at least cover most, if not all, of the side walls. In this position, right screen 133 is located in the same plane as the left screen 131 in its viewing position of FIG. 1. Furthermore, in their respective viewing positions, the right screen 133 and left screen 131 are each located at their respective fixed distance from the projection booth (or a projector in its operating position for projecting onto the viewing screen). Thus, an image or video from the projector will be properly focused onto left screen 131 in the configuration of FIG. 1, and another projected image from the projector will also be properly focused on right screen 133 in the configuration of FIG. 4.

When curtains 121 and 123 are in their extended positions (e.g., at least covering most of the side walls), respective screens 131, 133 in stowed positions will be hidden and protected by the curtain coverings. The single exposed screen in viewing position, whether 131 or 133, is correctly positioned to reflect an image projected by any projector in the projection booth (not shown). One or more projectors can be used for projecting content of different formats. Furthermore, different projectors can operate from different positions, or a given projector can be moved into a fixed or predetermined operating position for projecting content onto the viewing screen, e.g., moved along a rail parallel to the screen into a center position.

The opening and closing of curtains 121 and 123 and movement of screens 131 and 133 can be motorized or manually operated for implementing principles of the present invention.

In the example of FIGS. 1-4, both screens are shown as substantially flat screens. In other embodiments, one or both screens may be curved, i.e., at least having a curved front surface for viewing projected content. Since screens 131 and 133 are mounted for transport on the same screen rail 130, they can be configured to be positioned at substantially the same location, e.g., being approximately coincident, when they are moved into their respective viewing positions at the front wall to ensure proper alignment with the projector(s) and audience. Various alignment aids or mechanisms can be used for positioning the screens at the desired locations, for example, a mechanical detent on the track or rail, a cane bolt latch, or other fixed reference point such as an alignment mark on the wall or floor. For a curved screen, it is more important to position it at a given lateral position so that the center of the screen can be properly positioned in a repeatable manner. For a flat screen, its lateral positioning is less critical, as long as the projected image can be shown entirely on the screen without being truncated by the edges of the screen.

However, due to possible differences in dimensions or alignment needs, the two screens may not occupy exactly the same space or location when they are in their respective viewing positions along the front wall. For simplicity of discussion, the term “viewing position” may also be used to refer generally to either screen being in position for proper viewing of their respective content format, e.g., along the front wall in the layout such as that in FIGS. 1-4.

If both screens 131, 133 are flat screens, the viewing positions will lie in a same plane (assuming similar thickness for both screens). If one of the screens is curved and the other is flat, or if the screens have different curvatures, then the screens' viewing positions, though not in the same plane, are still substantially coincident and occupying approximately the same location.

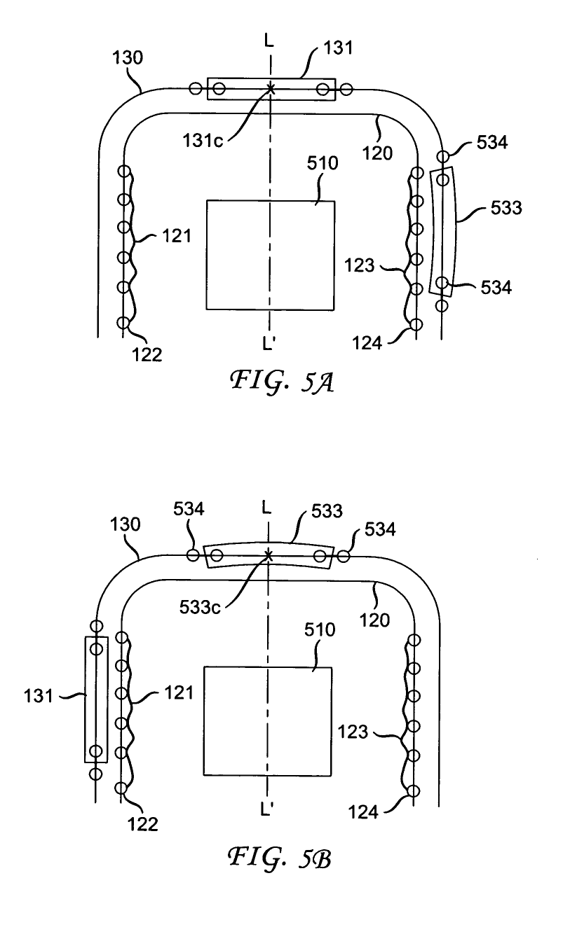

This is shown in FIGS. 5A-B, which are top views of two configurations for the left screen 131 and a right screen 533 that has at least a curved front surface. The curved screen 533 is supported by rollers 534 and mounted for transport along rail 130. As understood by one skilled in the art, the roller and mounting mechanism for a curved screen may be different from that for a flat screen, e.g., with more rollers and/or other components providing added support and/or stability during movement of the screen. FIG. 5A shows the screen 131 in its viewing position and curved screen 533 in its stowed position, which may be along adjacent walls in a viewing room. FIG. 5B shows the screen 131 in its stowed position and the curved screen 533 in its viewing position.

Regardless of the type of screens used, the system is configured such that each time a screen is moved to its viewing position, it is placed at a fixed or predetermined distance (e.g., optimized for projection focus, alignment, and so on) from the projecting booth or from its corresponding projector in operating position. In layouts typically used for professional media reviews, the projector is on-axis with the centerline of the screen, and usually housed in another room (e.g., a projection booth) with images projected through a soundproof window. The distance between the screen and the corresponding projector can be defined by any appropriate reference points, e.g., between a center point on the screen and a given point of the projector's operating position, or between a given point on the screen and a reference point for the projecting booth. By mounting both screens on the same fixed rail, each screen can be accurately positioned at its respective distance from the projector in a repeatable manner, regardless of the number of screen exchanges. However, due to differences in screen dimensions and/or curvatures, the respective screen-to-projector distances may be different for the two screens.

If a single projector is used for projecting content of different formats onto the respective screens, each screen at its viewing position is positioned at a suitable distance from the projector, thus minimizing the need for major equipment adjustments when switching from one screen to the other. In one embodiment, both screens at their respective viewing positions are located at a common (i.e., same) distance from the projector, and each screen can be repeatably positioned at that distance for each screen exchange. If more than one projector is used, e.g., one for projecting content of a first format, and another for projecting content of a second format, then the appropriate projector can be moved into the proper operating position as needed.

In general, each screen's viewing position also has a fixed spatial relationship with respect to the audience area. In one configuration, each viewing position is centered with respect to the audience area in the lateral (i.e., left to right) direction. This is shown in FIG. 5A and FIG. 5B, where the center point 131C of screen 131 or 533C of screen 533 lies along an axis LL′ that is substantially perpendicular to the screen's viewing surface and LL′ coincides with a center line dividing the left and right halves of the audience area 510.

Since the screens 131, 133 are configured to travel along rail 130 horizontally around the room (instead of being arranged vertically, one above the other), the review room 100 only needs to be high enough to accommodate the rail and other support assembly for the screens. Furthermore, stowing the unused screen along a side wall of the room represents an efficient use of the limited space typically found in screening rooms.

In some embodiments, screens 131 and 133 may be provided with a latching mechanism (not shown) to provide a positive retention at the viewing position. An example of a suitable latching mechanism is a cane bolt latch attached to the back or side of each of screens 131 and 133, with the cane bolt configured to engage with a hole in the floor, or in a floor-mounted block, to ensure that screens in the viewing position are repeatable positions. Such a latching system has the additional advantage of substantially preventing air currents in the room from causing the screen to sway. In still other embodiments, other latching systems may be used, for example, a latching system may positively engage a screen in viewing position to the front wall 101 to achieve similar benefits.

Aside from the example shown in FIGS. 1-4, a different sequence (not shown by figures) can also be used for changing the viewing screen from the left screen 131 to the right screen 133. For example, starting with the configuration of FIG. 1, the sequence starts by only opening or retracting the left curtain 121 away from the front wall. Left screen 131 at its viewing position is then moved through its intermediate position to its stowed position along left wall 102. Left curtains 121 are then closed, covering the screen 131. In this first part of the sequence, right screen 133 remains protected by right curtain 123 throughout the movement of left screen 131. Next, the right screen 123 is opened by retracting away from the front wall 101. Right screen 133 is moved through its intermediate position to its viewing position along the front wall 101, and right curtain 123 is closed to cover the right wall 103. In the second part of this sequence, left screen 131 remains protected by closed left curtain 121 throughout the movement of right screen 133.

Both sequences described above are reversible, i.e., can be used by reversing the order of the various steps, and either sequence can be used to move one of two screens from its stowed position into viewing position, and vice versa.

These sequences allow the conversion of review room 100 from high quality 3D projection to high quality 2D projection to occur in less than a minute. This represents a significant advantage over conventional review rooms with a single screen, which are constrained to show only one or the other content format, or high quality 3D but poor quality 2D.

Other sequences with different orders or combinations of curtain and screen movements and modes of operation can also be used, including, for example, moving the screens into respective positions at the same time (as opposed to moving one screen at a time or sequentially), or automating the movement of screens and/or curtains by suitable controllers, with the choice of sequence or operating mode being a policy decision based on various factors such as safety, ease of operation and costs, among others.

By avoiding the use of retractable or rolled-up type of screens, embodiments of the present invention also overcome the constraints presented by the fragile nature of typical 3D screens, while facilitating configuration changes to accommodate different content formats as well as storage of different screens within the limited space in typical review rooms.

Although the above principles are particularly well-suited for use in screening rooms, they can also be adapted for use in other projection viewing facilities or venues.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A projection system, comprising:
a first screen movable on a rail between a first viewing position and a first stowed position;
a second screen movable on the rail between a second viewing position and a second stowed position;
wherein, when the first screen is in the first viewing position for receiving projected content of a first format, the second screen is in the second stowed position; and when the second screen is in the second viewing position for receiving projected content of a second format different from the first format, the first screen is in the first stowed position.

2. The system of claim 1, wherein the first and second viewing positions are substantially coincident.

3. The system of claim 1, wherein the first and second viewing positions are located in a same plane.

4. The system of claim 1, wherein the first and second screens are both flat.

5. The system of claim 1, wherein at least one of the first and second screens is curved.

6. The system of claim 1, wherein the rail is provided above the first and second screens.

7. The system of claim 1, further comprising:
at least one projector for projecting content onto at least one of the first and second screens;
wherein the first screen at the first viewing position is at a first predetermined distance from the at least one projector, and the second screen in the second viewing position is at a second predetermined distance from the at least one projector.

8. The system of claim 7, wherein the first predetermined distance is optimized for projecting content of the first format, and the second predetermined distance is optimized for projecting content of the second format.

9. The system of claim 7, wherein the first predetermined distance is equal to the second predetermined distance.

10. The system of claim 7, wherein the at least one projector is a single projector for projecting content of the first format onto the first screen, and for projecting content of the second format onto the second screen.

11. The system of claim 7, wherein the at least one projector includes a first projector for projecting content of the first format and a second projector for projecting content of the second format.

12. The system of claim 1, wherein the first format is 3-dimensional format, and the second format is 2-dimensional format.

13. The system of claim 12, wherein the first screen is a silver screen, and the second screen is a matte screen.

14. The system of claim 1, wherein at least one of the first and second screens is provided as an integral unit.

15. The system of claim 1, further comprising a first curtain for use in conjunction with the first screen and a second curtain for use in conjunction with the second screen.

16. The system of claim 15, wherein each of the first and second curtains is configured for covering the respective first and second screens in the respective stowed positions.

17. The system of claim 1, wherein the system is provided for use in a room for viewing content in at least one of the first and second formats.

18. A method of projecting content with different formats, comprising:
providing a first screen movable on a rail between a first viewing position and a first stowed position, the first screen compatible with viewing content of a first format;
providing a second screen movable on the rail between a second viewing position and a second stowed position, the second screen compatible with viewing content of a second format different from the first format;
performing at least one of:
(a) projecting content of the first format onto the first screen at the first viewing position while keeping the second screen in the second stowed position; and
(b) projecting content of the second format onto the second screen at the second viewing position while keeping the first screen in the first stowed position.

19. The method of claim 18, wherein the first and second viewing positions for the respective first and second screens are substantially coincident.

20. The method of claim 18, wherein the first and second viewing positions are located in a same plane.

21. The method of claim 18, wherein one of the first and second formats is 2-dimensional format and the other one of the first and second formats is 3-dimensional format.

22. The method of claim 18, further comprising:
providing a projector for projecting content of the first and second formats.

23. The method of claim 22, further comprising:
during step (a), supporting the first screen on the rail at a first distance from the projector, the first distance being optimized for projecting content of the first format; and
during step (b), supporting the second screen on the rail at a second distance from the projector, the second distance being optimized for projecting content of the second format.

24. The method of claim 23, wherein the first distance is equal to the second distance.

25. The method of claim 18, further comprising:
providing a first projector for projecting content of the first format; and
providing a second projector for projecting content of the second format.

26. The method of claim 25, further comprising:
during step (a), supporting the first screen on the rail at a first distance from the first projector, the first distance being optimized for projecting content of the first format; and
during step (b), supporting the second screen on the rail at a second distance from the second projector, the second distance being optimized for projecting content of the second format.

27. The method of claim 18, further comprising:
providing a first curtain for use in conjunction with the first screen and a second curtain for use in conjunction with the second screen.

28. The method of claim 27, further comprising:
positioning one of the first and second curtains for covering one of the first and second screens in the respective stowed positions.
